(19) United States
(12) Patent Application Publication
(10) Pub. No.: US 2009/0194565 A1
(43) Pub. Date: Aug. 6, 2009

(54) WET CEMENT DISPENSING APPARATUS WITH CLEANING AND ACCESS FEATURES

(76) Inventor: Damian L. Lang, Waterford, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/024,233

(22) Filed: Feb. 1, 2008

(51) Int. Cl. B67D 5/64; G01F 11/20

(52) U.S. Cl. 222/164; 222/413

(57) ABSTRACT

An improved wet cement dispensing apparatus having a tilting hopper and a hinged, angled auger tube for aiding in the cleaning of the apparatus and for delivering grout to elevated and hard to reach locations. The hopper can be locked in a first position for dispensing grout and in a tilted position for cleaning. The hopper rotates about a vertical axis. The dispensing end of the auger tube preferably extends to near the top edge of the hopper.

### BACKGROUND OF THE INVENTION

1. Field of the Invention

This invention relates generally to the field of wet cement dispensers and more particularly to a wet cement dispensing apparatus having a tilting hopper and a hinged, angled auger tube for aiding in the cleaning of the apparatus and for delivering grout to elevated and hard to reach locations.

2. Description of the Related Art

Traditional wet cement (i.e., “grout”) dispensers such as those described in U.S. Pat. No. 6,112,955 to Lang and U.S. Pat. No. 6,206,249 to Lang, which are herein incorporated by reference, combine a hopper for holding grout and an auger tube containing a motorized auger that extends horizontally from the bottom of the hopper for conveying the grout a short distance away from the hopper. Typically, a flexible hose extends from the end of the auger tube for accurately channeling grout to the area where it is to be applied.

In the sequence of normal operation, a cement truck or other mixing container first pours grout into the open top of the hopper which funnels the grout into the accepting end of the auger tube. The entire dispenser is then lifted by a forklift to a position above an area where grout is to be applied. The motorized auger is then activated. As the auger rotates within the tube, the grout is driven from the accepting end of the tube to its dispensing end. The grout is then forced through the flexible hose to the area of application. To control the flow of grout, a worker pinches and releases the hose by hand. A small, radial gap between the perimeter of the auger and the inner surface of the auger tube allows the auger to continue to rotate when the hose is pinched closed without causing an excessive build-up of pressure on the grout within the tube or the hose.

One problem associated with grout delivery systems of the type described is that it is difficult, and sometimes impossible, to deliver grout to elevated areas that offer little overhead space. In order to properly position a traditional grout dispenser during use, there must be a sufficient amount of space above an application site to accommodate the entire dispensing apparatus, as well as the boom and carriage of the forklift that carries it. This can be a severe limitation, because many work areas do not provide the requisite amount of overhead space and therefore necessitate alternative, more cumbersome means of grout application.

Another common problem among conventional grout dispensers is the difficulty associated with cleaning. After use, excess grout must be cleaned out of the hopper and the auger tube before the grout is able to cure. This is typically accomplished by spraying the interior surfaces of the hopper and the auger tube with pressurized water to flush the residual grout out of the dispenser. However, much of the interior of the auger tube is difficult to reach, particularly the portions of the tube's interior that are closest to its longitudinal center.

Yet another problem associated with traditional grout dispensers is excessive grout run-out after the motorized auger has been deactivated. This occurs when there is grout left in the auger tube after the auger has stopped rotating. Gravity forces some of the leftover grout to feed into the flexible hose and out to the work area, where it must be disposed of.

### BRIEF SUMMARY OF THE INVENTION

It is therefore the purpose of this invention to provide a grout dispensing apparatus that is easy to clean and capable of delivering grout to elevated and difficult to reach locations. It is a further purpose of this invention to provide such a grout dispensing apparatus that also prevents excessive grout run-out after being shut off.

In accordance with the purposes of the present invention, there is provided a grout dispenser having a base, a hopper that can be tilted relative to the base, and an upwardly angled auger tube that can be folded along its length. The angled auger tube extends from the bottom of the hopper at an acute angle to a height greater than that of the hopper. Grout is poured into the open top of the hopper and is funneled into the accepting end of the auger tube. The entire apparatus is then lifted, such as by a forklift, into position. The rotating auger drives the grout upwardly through the tube and into a flexible hose that extends downwardly from the tube's dispensing end.

Because the dispensing end of the auger tube is elevated relative to the rest of the dispenser's components, the dispenser need not be lifted as high as conventional grout dispensers (i.e., those having horizontally disposed auger tubes) to reach the same overall height. Moreover, because the angled auger tube is smaller than the carriage, boom, and hopper, the invention can reach into much tighter overhead areas than previous dispensers. Another benefit associated with the upwardly angled auger tube is that gravity prevents excess grout from running out of the tube after the auger has stopped rotating.

The hopper is pivotably affixed to the base, enabling the hopper to tilt in the direction of the auger tube. The auger tube is hinged near its longitudinal center enabling its more elevated portion to fold back toward the hopper. For cleaning, the auger is removed from the auger tube, the auger tube is folded, and the hopper is tilted. The interiors of the hopper and the auger tube are then sprayed with pressurized water. The folded auger tube provides convenient access to the interior surfaces of the tube nearest its longitudinal center. The tilted hopper allows water and excess grout to run out through the neck of the folded tube.

A spring-loaded pivot latch is mounted to the base of the dispenser. During operation, the pivot latch keeps the hopper locked in its normal, upright position. For cleaning, an operator manually disengages the latch, allowing the hopper to tilt. When the hopper is pivoted back to its normal, upright position, the pivot latch automatically reengages the hopper again, thereby locking it into place.

### BRIEF DESCRIPTION OF THE SEVERAL VIEWS OF THE DRAWINGS

FIG. 1 is a perspective view illustrating the invention in its normal, upright position.

FIG. 2 is an exploded view illustrating the hopper, auger tube, and base of the invention.

FIG. 3a is a perspective view illustrating the hopper and base of the invention with the roll pin engaging the retaining block.

FIG. 3b is a perspective view illustrating the hopper in the cleaning position and the roll pin disengaged from the retaining block.

FIG. 4 is a side elevation view illustrating the invention in the cleaning position.

FIG. 5 is a partial perspective view illustrating an alternative embodiment of the auger tube of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

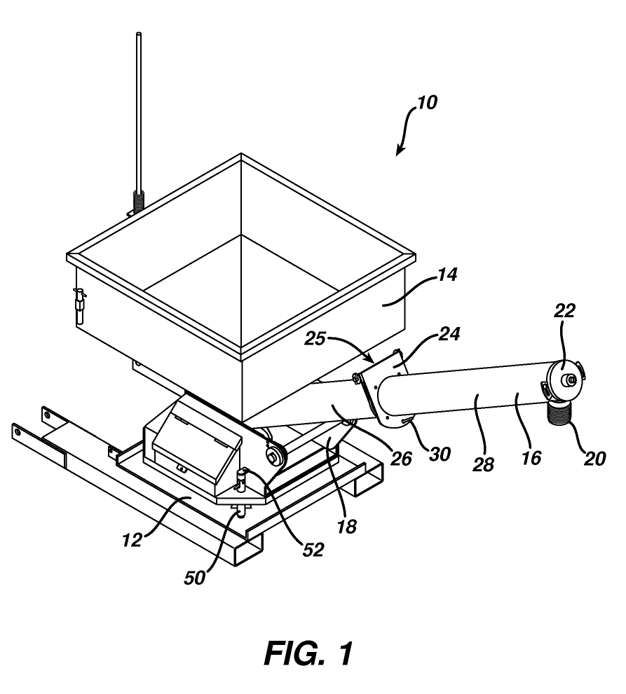

Referring to FIG. 1, the grout dispenser 10 has a base 12, a hopper 14, and an auger tube 16 containing a conventional, motorized auger. All components of the dispenser are fabricated from steel unless otherwise noted, although all other durable, rigid materials, such as composites, aluminum, and plastic, are also contemplated. Terms such as “vertical”, “horizontal”, “top”, and “bottom” are used herein to describe the orientation and position of components when the dispenser is seated on a flat surface in an operable orientation.

The hopper 14 is a box-shaped container that is wider at its top end than its bottom end in order to “feed” fluent material downwardly along vertical and sloped sidewalls. The top of the hopper 14 is open for accepting grout, such as from a larger container, and the bottom of the hopper is open to the auger tube 16 for dispensing grout. Additionally, a U-shaped cradle 18 is rigidly affixed to the bottom of the hopper 14.

The auger tube 16 is an elongated, cylindrical body that is rigidly affixed to the bottom and/or front of the hopper 14. The auger tube 16 extends at an acute angle, relative to the surface upon which the dispenser sits, to a dispensing end that has an elevation greater than the rest of the auger tube 16, and preferably to about the top edge of the hopper 14. The accepting end of the tube 16, which is beneath the hopper 14, has an upwardly-facing aperture below the open bottom of the hopper for accepting grout from the bottom end of the hopper 14. In an alternative embodiment in which the auger tube attaches to the front of the hopper, the accepting end of the tube has a horizontally-facing aperture facing into the hopper for accepting grout from the bottom end of the hopper. A cylindrical discharge spout 20 extends downwardly from the tube 16 adjacent the tube's elevated dispensing end for dispensing grout. A removable cap 22 fits over the dispensing end of the tube 16 and a hose (not shown) is attached to the spout 20.

Within the auger tube 16 is a removable auger drivably linked to a hydraulic motor (not shown). During operation of the dispenser 10, the motor rotates the auger in a conventional manner, and the auger drives grout from the accepting end of the tube 16 (beneath the hopper 14) to its dispensing end. Because the dispensing end of the auger tube 16 is elevated relative to its accepting end, the force of gravity on the grout prevents any significant amount of unused grout left in the auger tube 16 from exiting the discharge spout 20 after the motor has been deactivated. Instead, the grout flows downhill to the accepting end of the auger tube 16.

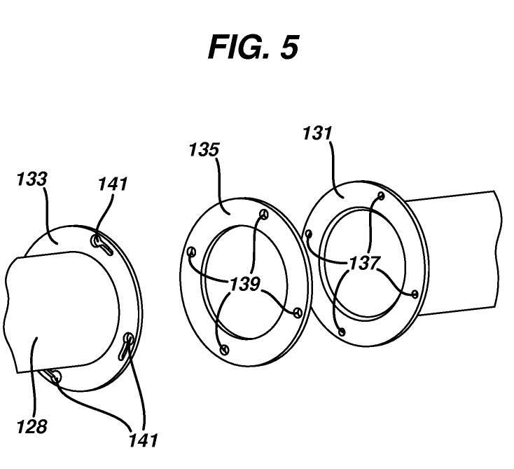

A hinge plate 24 transversely divides the auger tube 16 into two cylindrical segments, one being a proximal segment 26 that is rigidly mounted to the hopper 14, and the other being a distal segment 28 that is more elevated and that is capable of being folded back toward the hopper about the axis of the hinge plate's hinge 25. A releasable tube pivot latch 30 is affixed to the hinge plate 24, on the opposite side as the hinge 25, for preventing the tube 16 from folding while the latch 30 is engaged. Of course, the hinge can be placed on the opposite side as that shown, and the latch can be reversed. Other structures that permit relative movement of the proximal and distal segments 26 and 28 are contemplated. It is contemplated that other structures, that permit separation of the segments of the auger tube 16, can be substituted for the hinge. For example, referring to FIG. 5, the proximal and distal segments 126 and 128 of the tube 116 have annular flanges 131 and 133 that coaxially engage each other with an annular sealing disk 135 interposed therebetween. A set of four bolts (not shown) engage three corresponding sets of four radially-disposed, axially aligned apertures 137, 139, and 141 (one of the apertures in set 141 is not within view, but is substantially identical to those that are) in each of the flanges 131 and 133 and the sealing disc 135 for removably securing all of the components together. The apertures 137 are threaded to receive the bolts in a conventional manner, and the keyhole apertures 141 permit separation of the flanges 131 and 133 without completely removing the bolts from the apertures 137.

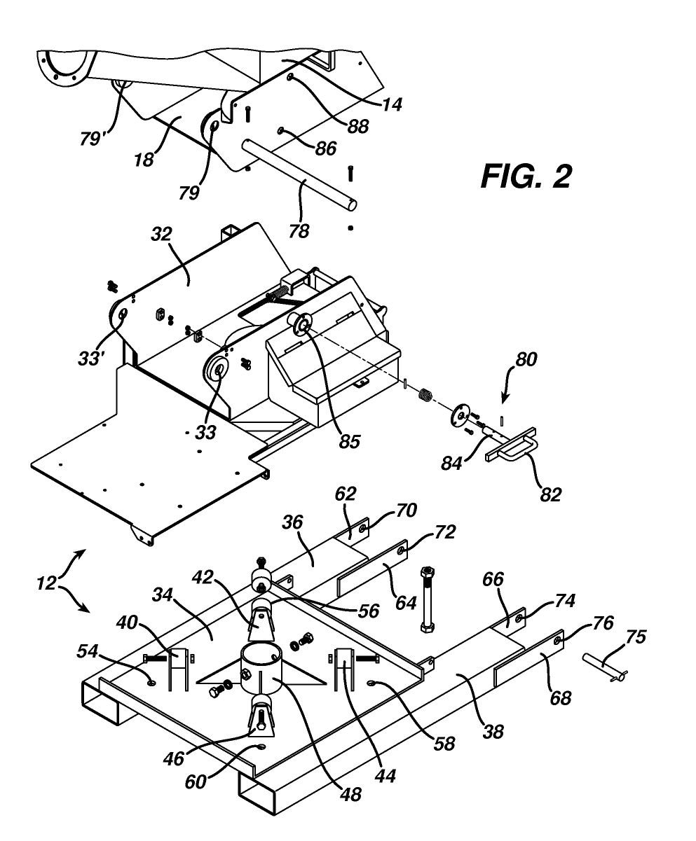

Referring to FIG. 2, the base 12 of the dispenser 10 has four major components: a carriage 32, a turntable 34, and two fork tubes 36 and 38. The carriage 32 sits on top of the turntable 34 and is essentially U-shaped for matingly receiving the cradle 18 of the hopper 14, which is slightly narrower. Thus, the hopper 14 is mounted rigidly to the cradle 18, the cradle 18 is pivotably mounted to the carriage 32, and the carriage 32 is rotatably mounted to the turntable 34.

The turntable 34 is preferably a rectangular plate, with a top surface facing vertically upwardly and a bottom surface facing vertically downwardly. The turntable has four rollers 40, 42, 44, and 46 (with horizontal axes of rotation) extending upwardly from its top surface. The rollers 40-46 are disposed around a circle and are spaced about 90 degrees apart. A cylindrical pivot post 48 extends upwardly from the surface of the turntable 34 at about the center of the circle equidistant from the rollers 40-46. The bottom surface of the carriage 32 has a slightly smaller male post (not shown) that extends downwardly therefrom and rotatably engages the female pivot post 48. The rollers 40-46 seat against the underside of the carriage 32, and therefore the hopper 14 can be rotated about the axis of the pivot post 48 relative to the turntable 34 with the rollers 40-46 supporting the carriage vertically and permitting rotation of the carriage about the vertical axis of the post 48.

The turntable 34 (FIG. 2) has four holes 54, 56 (not within view), 58 and 60, each hole providing a vertical passageway through one of the turntable's four corners. A cylindrical brake pin mount 50 (see FIG. 1) extends vertically from a hole in the carriage 32 for accepting a brake pin 52. To prevent the carriage 32 from rotating relative to the turntable 34, the brake pin 52 is inserted into the top of the brake pin mount 50 and is passed through the mount 50 and into one of the four holes 54-60 in the turntable 34. Thus, the hopper 14 may be rotated to and locked into any one of four positions desired by an operator. Of course, more than four holes can be formed. Alternative mechanisms for locking the hopper 14 in position are also contemplated.

Still referring to FIG. 2, the fork tubes 36 and 38 are rigidly affixed to the bottom surface of the turntable 34, such as by welding, and are oriented parallel to one another. The tubes 36 and 38 are made from rectangular steel tubing and are spaced apart from each other appropriately for receiving therein the forks of a conventional forklift. The flat members 62, 64, 66, and 68 are rigidly affixed to the sides of the fork tubes 36 and 38, and each flat member has a hole 70, 72, 74, and 76 into which the retaining pins 75 and 77 (retaining pin 77 is not pictured, but is identical to pin 75) may be horizontally inserted. The retaining pins act as a gate against the upraised portions of a forklift's forks to prevent the dispenser 10 from sliding off of the forks.

The cradle 18 sits within, and is pivotably attached to, the carriage 32 by a pivot pin 78 that passes horizontally through axially-aligned holes 79 and 79′ (hole 79′ is not within view, but is identical to hole 79) and 33 and 33′ in the two opposing sides of the cradle 18 and the carriage 32. This allows the hopper 14 to tilt to one side about the horizontal axis of the pivot pin 78.

The cradle 18 has two holes 86 and 88 positioned one above the other, and each provides a horizontal passageway through one of the cradle's sidewalls. A spring-loaded hopper pivot latch 80 is affixed to the sidewall of the carriage 32. The pivot latch 80 has a handle 82 with an elongated locking pin 84 extending therefrom for axially engaging a flanged pin sheath 85 that is rigidly mounted to the carriage 32. The locking pin 84 extends through the pin sheath 85 and the sidewall of the carriage 32 and can extend through one of the holes 86 and 88 in the sidewall of the cradle 18 to prevent the hopper 14 from pivoting about the pivot pin 78. During operation of the dispenser 10, the locking pin 84 engages the upper hole 88 in the cradle 18, thereby keeping the hopper 14 locked in its upright, dispensing position. The lower hole 86 is used for cleaning, as described below when the hopper is tilted.

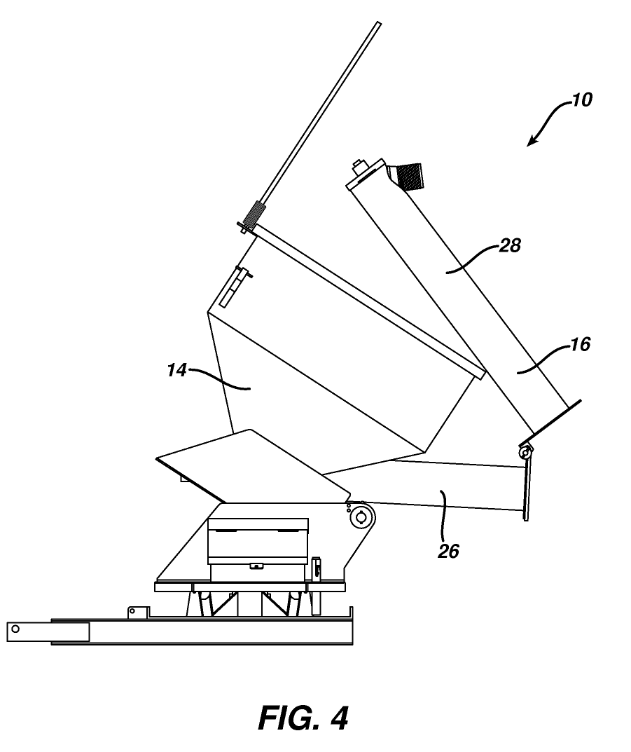

Referring to FIG. 4, an operator prepares the dispenser 10 for cleaning by first pulling the handle 82 of the spring-loaded hopper pivot latch 80 with sufficient force to disengage the locking pin 84 from the upper hole 88. The hopper 14 is then tilted to the cleaning position shown in FIG. 4, either by the operator manually tilting the hopper 14, or due to the force of gravity. Referring back to FIG. 1, the cap 22 is removed, and the auger is axially extracted from the auger tube 16. Because the auger tube 16 is tilted, the force of gravity aids in the removal of the auger. After the auger has been extracted, the pivot latch 30 is disengaged and the distal segment 28 of the auger tube 16 is folded back toward the hopper 14 as shown in FIG. 4. It is contemplated that the auger can alternatively be removed and the auger tube 16 folded before the hopper 14 is tilted.

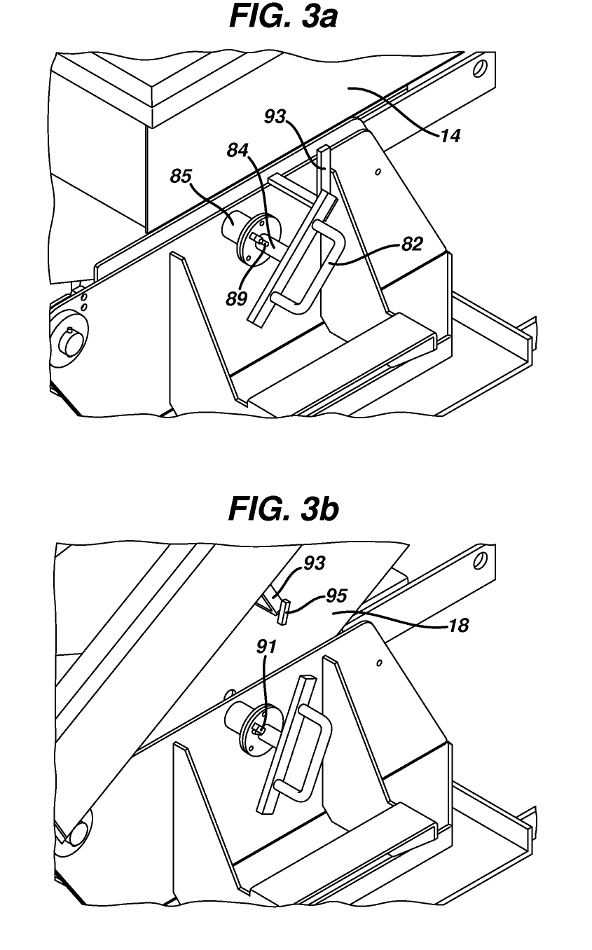

Referring now to FIGS. 3a and 3b, a roll pin 89 extends radially from the locking pin 84, and a retaining block 91 extends longitudinally from the outwardly-facing surface of the flanged portion of the pin sheath 85. The retaining block 91 holds the locking pin 84 from full insertion into the sheath 85. An L-shaped bracket 93 extends from the side of the hopper 14, and a contact bar 95 is rigidly mounted to the corner of the bracket 93. In order to keep the locking pin 84 axially disengaged from the upper hole 88 (shown in FIG. 2) while the operator tilts the hopper 14, the operator rotates the handle 82 about the axis of the locking pin 84 before tilting and brings the roll pin 89 to rest against the retaining block 91 (as shown in FIG. 3a). Referring to FIG. 3b, as the hopper 14 is tilted upwardly by the operator, the top surface of the contact bar 95 (attached to the moving hopper) engages the bottom surface of one end of the handle 82, thereby rotating the handle 82 counterclockwise. The rotational movement of the handle 82 causes the roll pin 89 to slide off of the retaining block 91, thereby allowing the locking pin 84 to be further inserted through the sheath 85, and drawn into contact with the sidewall of the cradle 18 by a spring. The cradle sidewall then slides along the tip of the locking pin 84 while the hopper 14 is being tilted. When the hopper 14 is fully tilted, the locking pin 84 is in alignment with the lower hole 86 in the cradle, and the locking pin 84 is drawn into the lower hole 86 by the spring, thereby locking the hopper 14 in its tilted position (as shown in FIG. 4).

Once the dispenser 10 is in the cleaning position shown in FIG. 4, the interiors of the hopper 14 and the auger tube 16 can be scrubbed with a brush and/or sprayed with pressurized water. The water can be directed through the open top of the hopper 14, into the open end of the proximal segment 26 of the auger tube 16, and into both open ends of the distal segment 28. In the cleaning position shown in FIG. 4, the proximal segment 26 of the auger tube is tilted at least slightly downward from horizontal, and if the surface upon which the dispenser 10 sits is relatively level, water and residual grout can flow freely out of the hopper 14 and through the proximal segment 26 during cleaning. Thus, water and grout flow by gravity out of all major areas of the dispenser 10.

In an alternative method for cleaning the dispenser 10, water is first sprayed or poured into the top of the hopper 14 while the hopper 14 is locked in its normal, upright position. The water accumulates in the hopper 14 and the auger tube 16, thereby diluting and loosening any residual grout therein. With the dispenser 10 partly or nearly full of water, the auger is activated. The rotation of the auger agitates the contents of the dispenser 10 and further loosens any grout that may be built-up within the auger tube 16, while at the same time possibly pushing some of the grout and water mixture out of the tube 16. The cap 22 is then removed and the hopper 14 is tilted to flush the remaining mixture out of the dispenser 10. The hopper and auger tube are subsequently cleaned of any remaining grout and possibly sprayed with clean water so that all water and residue can run downhill out of the distal portion of the auger tube.

To move the hopper 14 back to its upright position, the operator pulls the hopper pivot latch handle 82 to disengage the locking pin 84 from the lower hole 86, and then rotates the handle 82 about the axis of the locking pin 84 and brings the roll pin 89 to rest on the retaining block 91. The operator then tilts the hopper 14 upwardly. As the hopper 14 is being tilted, the bottom surface of the contact bar 95 engages the top surface of one end of the handle 82, thereby rotating the handle 82 clockwise. The rotational movement of the handle 82 causes the roll pin 89 to slide off of the retaining block 91, thereby allowing the locking pin 84 to be further inserted into the sheath 85, and drawn into contact with the sidewall of the cradle 18. The cradle sidewall then slides along the tip of the locking pin 84 while the hopper 14 is being tilted. When the hopper 14 is fully returned to its upright position, the locking pin 84 is in alignment with the upper hole 88 in the cradle, and the locking pin 84 is drawn into full insertion in the upper hole 88, thereby locking the hopper 14 in its upright position. The auger is returned to the tube 16 after the tube 16 is unfolded. The cap 22 is replaced and the dispenser is ready for use or storage.

Various mechanisms are shown to lock parts of the dispenser in position. Any similar mechanisms can be substituted for the structures shown, as will become apparent. For example, the locking pin 84 is inserted through aligned holes. This can be replaced by a friction brake or another structure that accomplishes the purpose of locking the otherwise relatively moveable parts to one another. Additionally, although various pivot pins are shown, any structure that produces relative movement about an axis can be substituted, as will be understood by a person of ordinary skill.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved grout dispensing apparatus having a hopper mounted to a base with an auger tube extending from the hopper, the improvement comprising:
a. the hopper pivotably attaches to the base for tilting the hopper from a dispensing position to a cleaning position; and
b. the auger tube extends from a lower end of the hopper to an elevated end when the hopper is in the dispensing position.

2. The improved grout dispensing apparatus in accordance with claim 1, wherein a hopper pivot latch is affixed to the base to releasably lock the hopper in the dispensing position.

3. The improved grout dispensing apparatus in accordance with claim 1, wherein a hopper pivot latch is affixed to the base to releasably lock the hopper in the cleaning position.

4. The improved grout dispensing apparatus in accordance with claim 1, wherein the hopper pivot latch is spring-loaded.

5. The improved grout dispensing apparatus in accordance with claim 4, wherein the hopper pivot latch is adapted to be disengaged to prevent locking the hopper in one of the positions.

6. The improved grout dispensing apparatus in accordance with claim 4, wherein the hopper pivot latch engages a retaining block extending from the base for preventing the pivot latch from locking the hopper in one of the positions.

7. The improved grout dispensing apparatus in accordance with claim 1, wherein the auger tube is adapted to be separated along its length for opening the auger tube for cleaning.

8. The improved grout dispensing apparatus in accordance with claim 7, wherein the auger tube has a proximal axial segment and a distal axial segment, the distal axial segment pivotably attaches to the proximal axial segment by at least one hinge for allowing the distal axial segment to pivot between an extended position and a folded position, and a tube latch engages both segments for releasably locking the distal axial segment in the extended position.

9. The improved grout dispensing apparatus in accordance with claim 7, wherein the auger tube has a proximal axial segment with a flange and a distal axial segment with a flange, the flange of the distal axial segment being removably secured to the corresponding flange of the proximal axial segment.

10. A method of cleaning a grout dispensing apparatus having a tilting hopper and an auger tube containing an auger, the method comprising:
a. directing water into the hopper;
b. activating the auger;
c. deactivating the auger; and
d. tilting the hopper toward the auger tube, thereby tilting the auger tube to permit water to drain out of the hopper through the auger tube.

11. A method of cleaning a grout dispensing apparatus having a tilting hopper and a folding auger tube containing a removable auger, the method comprising:
a. tilting the hopper in the direction of the auger tube;
b. removing the auger from the auger tube;
c. folding the auger tube;
d. directing water into the hopper and into the auger tube; and
e. allowing the water to drain through the auger tube.

12. The method of cleaning in accordance with claim 11, further comprising disengaging an auger tube pivot latch before folding the auger tube open and disengaging a hopper pivot latch before tilting the hopper.
